(19) United States
(12) Patent Application Publication
(10) Pub. No.: US 2025/0138555 A1
(43) Pub. Date: May 1, 2025

(54) SEMI-AUTONOMOUS REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US); Monika Nagalla, Oshkosh, WI (US); John Zucca, Oshkosh, WI (US)

(73) Assignee: Oshkosh Corporation, Oshkosh, WI (US)

(21) Appl. No.: 18/925,756

(22) Filed: Oct. 24, 2024

Related U.S. Application Data
(60) Provisional application No. 63/545,984, filed on Oct. 27, 2023.

(51) Int. Cl. G05D 1/667; B65F 3/00; G05D 111/10; G05D 111/30

(52) U.S. Cl. CPC G05D 1/667; B65F 3/00; G05D 2111/17; G05D 2111/30

(57) ABSTRACT

A system for controlling the operation of a refuse collection vehicle includes at least one first sensor coupled to the vehicle to detect objects during an approach, at least one second sensor to detect the vehicle's position during the approach, and one or more processors. The processors receive object data from the first sensor and positional data from the second sensor, and use this information to identify a refuse container. Upon identifying the refuse container, the processors transmit a first instruction to the vehicle's control system to adjust operating parameters during the approach.

### CROSS-REFERENCE TO RELATED PATENT APPLICATIONS

This application claims the benefit of and the priority to U.S. Provisional Patent Application No. 63/545,984, filed Oct. 27, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

In some aspects, the techniques described herein relate to a system for controlling an operation of a refuse collection vehicle, the system including: at least one first sensor coupled to the refuse collection vehicle and configured to detect objects on one or more sides of the refuse collection vehicle during an approach; at least one second sensor configured to detect a position of the refuse collection vehicle during the approach; and one or more processors configured to: receive an object data from the at least one first sensor; receive a positional data from the at least one second sensor; identify a refuse container based at least on the object data and the positional data; and responsive to identifying the refuse container based at least on the object data, transmit a first instruction to a control system of the refuse collection vehicle to adjust at least one operating parameter of the refuse collection vehicle during the approach.

In some aspects, the techniques described herein relate to a system, wherein the at least one first sensor is at least one of a visible light camera, an infrared camera, a LiDAR sensor, a radar sensor, and a time-of-flight camera.

In some aspects, the techniques described herein relate to a system, wherein the at least one operating parameter is one of a braking amount, a steering angle, an acceleration amount, a gear engagement, a suspension stiffness, and a refuse container grabber actuation.

In some aspects, the techniques described herein relate to a system, further including: responsive to identifying the refuse container and transmitting the first instruction to the control system of the refuse collection vehicle to adjust the at least one operating parameter of the refuse collection vehicle during the approach, transmit a second instruction to cause an actuation of an engagement assembly to engage the refuse container; and responsive to receiving an indication of an engagement of the refuse container with the engagement assembly, update a database based at least on the positional data and the indication of the engagement of the refuse container with the engagement assembly.

In some aspects, the techniques described herein relate to a system, wherein receiving an indication of an engagement of the refuse container with the engagement assembly includes receiving a signal from an engagement sensor.

In some aspects, the techniques described herein relate to a system, wherein the engagement sensor is one of a visible light camera, an infrared camera, a LiDAR sensor, a radar sensor, a strain gauge, and a time-of-flight camera.

In some aspects, the techniques described herein relate to a system, wherein the engagement assembly includes at least one of a refuse container grabber and a fork.

In some aspects, the techniques described herein relate to a method controlling an operation of a refuse collection vehicle, the method including: receiving, by one or more processors, an object data from at least one first sensor; receiving, by the one or more processors, a positional data from at least one second sensor; identifying, by the one or more processors, a refuse container based at least on the object data and the positional data; and responsive to identifying the refuse container based at least on the object data and the positional data, transmitting, by the one or more processors, a first instruction to a control system of the refuse collection vehicle to adjust at least one operating parameter of the refuse collection vehicle during an approach of the refuse container.

In some aspects, the techniques described herein relate to a method, wherein the at least one first sensor is at least one of a visible light camera, an infrared camera, a LiDAR sensor, a radar sensor, and a time-of-flight camera.

In some aspects, the techniques described herein relate to a method, wherein the at least one operating parameter is one of a braking amount, a steering angle, an acceleration amount, a gear engagement, a suspension stiffness, and a refuse container grabber actuation.

In some aspects, the techniques described herein relate to a method, further including: responsive to identifying the refuse container and transmitting the first instruction to the control system of the refuse collection vehicle to adjust the at least one operating parameter of the refuse collection vehicle during the approach, transmitting, by the one or more processors, a second instruction to cause an actuation of an engagement assembly to engage the refuse container; and responsive to receiving an indication of an engagement of the refuse container with the engagement assembly, updating, by the one or more processors, a database based at least on the positional data and the indication of the engagement of the refuse container with the engagement assembly.

In some aspects, the techniques described herein relate to a method, wherein receiving an indication of an engagement of the refuse container with the engagement assembly includes receiving a signal from an engagement sensor.

In some aspects, the techniques described herein relate to a method, wherein the engagement sensor is one of a visible light camera, an infrared camera, a LiDAR sensor, a radar sensor, a strain gauge, and a time-of-flight camera.

In some aspects, the techniques described herein relate to a method, wherein the engagement assembly includes at least one of a refuse container grabber and a fork.

In some aspects, the techniques described herein relate to a refuse collection vehicle including: at least one first sensor coupled to the refuse collection vehicle and configured to detect objects on one or more sides of the refuse collection vehicle during an approach; at least one second sensor configured to detect a position of the refuse collection vehicle during the approach; and one or more processors configured to: receive an object data from the at least one first sensor; receive a positional data from the at least one second sensor; identify a refuse container based at least on the object data and the positional data; and responsive to identifying the refuse container based at least on the object data, transmit a first instruction to a control system of the refuse collection vehicle to adjust at least one operating parameter of the refuse collection vehicle during the approach.

In some aspects, the techniques described herein relate to a refuse collection vehicle, wherein the at least one first sensor is at least one of a visible light camera, an infrared camera, a LiDAR sensor, a radar sensor, and a time-of-flight camera.

In some aspects, the techniques described herein relate to a refuse collection vehicle, wherein the at least one operating parameter is one of a braking amount, a steering angle, an acceleration amount, a gear engagement, a suspension stiffness, and a refuse container grabber actuation.

In some aspects, the techniques described herein relate to a refuse collection vehicle, further including: responsive to identifying the refuse container and transmitting the first instruction to the control system of the refuse collection vehicle to adjust the at least one operating parameter of the refuse collection vehicle during the approach, transmit a second instruction to cause an actuation of an engagement assembly to engage the refuse container; and responsive to receiving an indication of an engagement of the refuse container with the engagement assembly, update a database based at least on the positional data and the indication of the engagement of the refuse container with the engagement assembly.

In some aspects, the techniques described herein relate to a refuse collection vehicle, wherein receiving an indication of an engagement of the refuse container with the engagement assembly includes receiving a signal from an engagement sensor.

In some aspects, the techniques described herein relate to a refuse collection vehicle, wherein the engagement sensor is one of a visible light camera, an infrared camera, a LiDAR sensor, a radar sensor, a strain gauge, and a time-of-flight camera.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is an example interface illustrating the detection of multiple refuse cans, according to an exemplary embodiment;

FIGS. 7A-7C are top views of the refuse vehicle of FIG. 1 with spatial awareness, illustrating the coverage zones of sensors and cameras, according to an exemplary embodiment;

FIG. 8 is a depiction of a system for automated vehicle trajectory planning and refuse container collection, according to an exemplary embodiment;

FIG. 9 is a flow diagram for automated refuse collection and database updating, according to an exemplary embodiment; and

FIG. 10 is a flow diagram of a process for detecting a refuse container and planning a trajectory to collect the refuse container, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a system for planning and executing a trajectory for a refuse collection vehicle is shown. For example, the system may include one or more of an object detection system, a vehicle awareness system, and a trajectory planning system. The object detection system may identify refuse containers for collection, the vehicle awareness system may detect a position of the vehicle and a surrounding environment, and the trajectory planning system may automatically plan and execute a trajectory for the refuse collection vehicle to collect a detected refuse container. The system may adjust and/or limit operations of the refuse collection vehicle based on one or more inputs/outputs of the system. The system may autonomously operate the refuse vehicle along the planned trajectory or may operate a display screen to prompt and/or guide an operator to transport the refuse vehicle along the planned trajectory. In one embodiment, the system may autonomously control the refuse collection vehicle upon reaching a threshold distance from a previously planned collection site. Additionally, the system may autonomously update one or more databases with data associated with the planned trajectory, operation of the vehicle, and the refuse container collection. The various methods, systems, and process described herein may be executed by a single system or executed by multiple systems.

### Refuse Vehicle

### Front-Loading Configuration

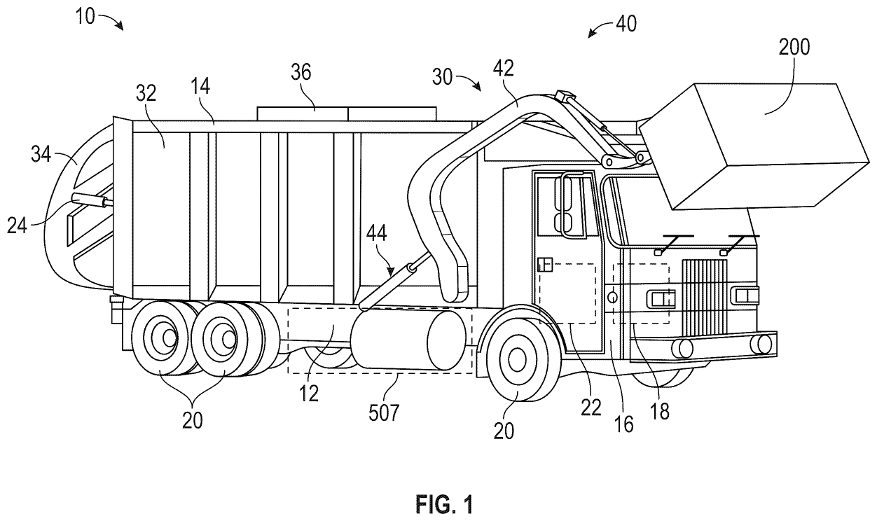

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment as described in greater detail in U.S. application Ser. No. 17/558,183, filed Dec. 12, 2021, the entire disclosure of which is incorporated by reference herein.

### Rear-Loading Configuration

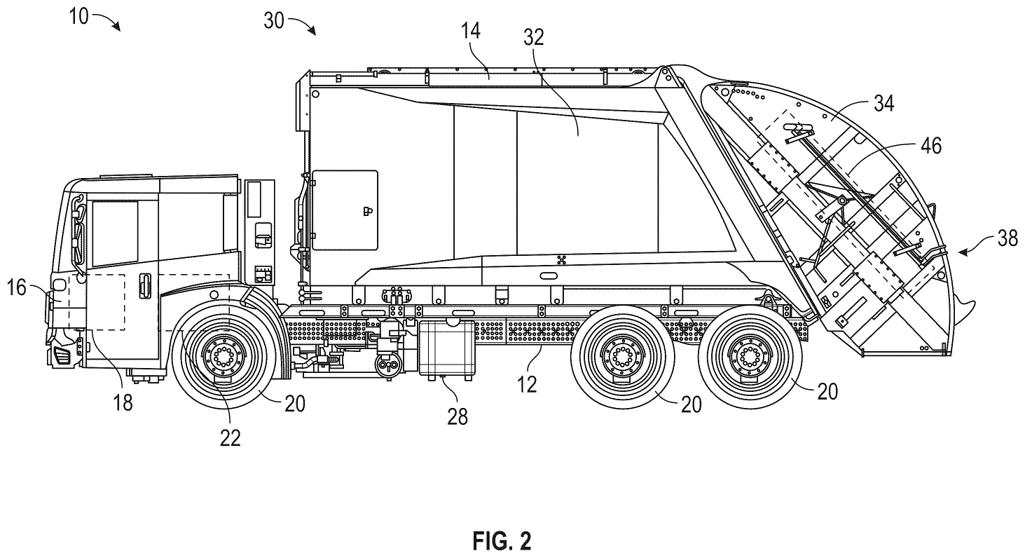

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

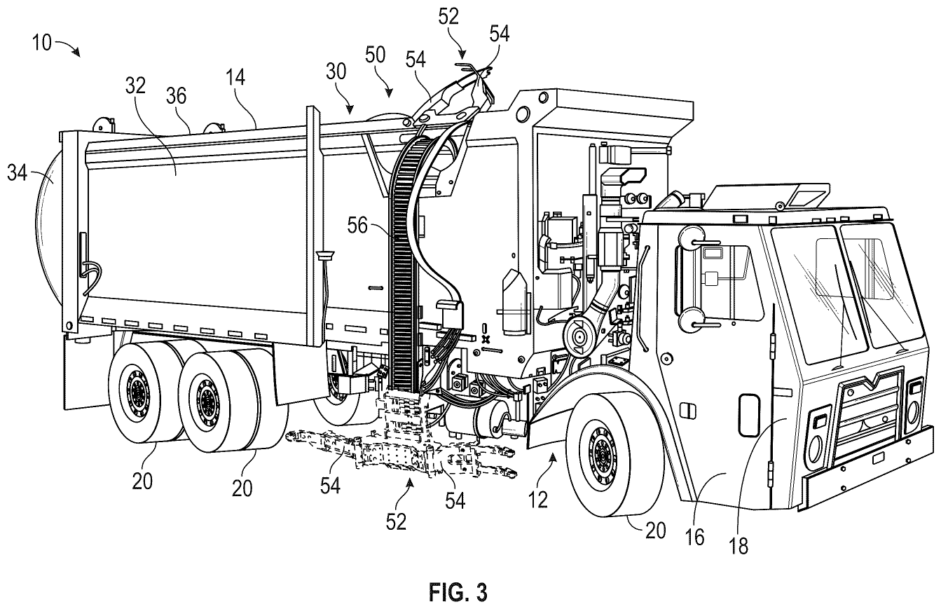

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

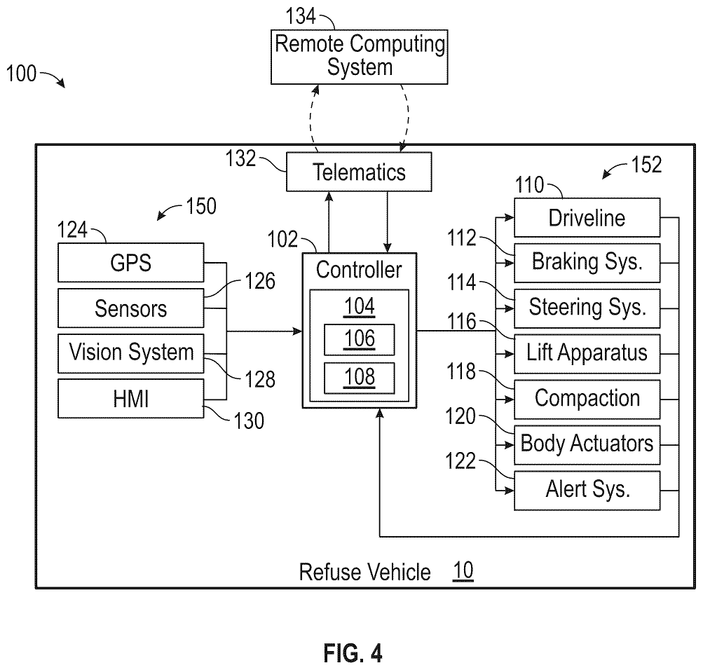

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

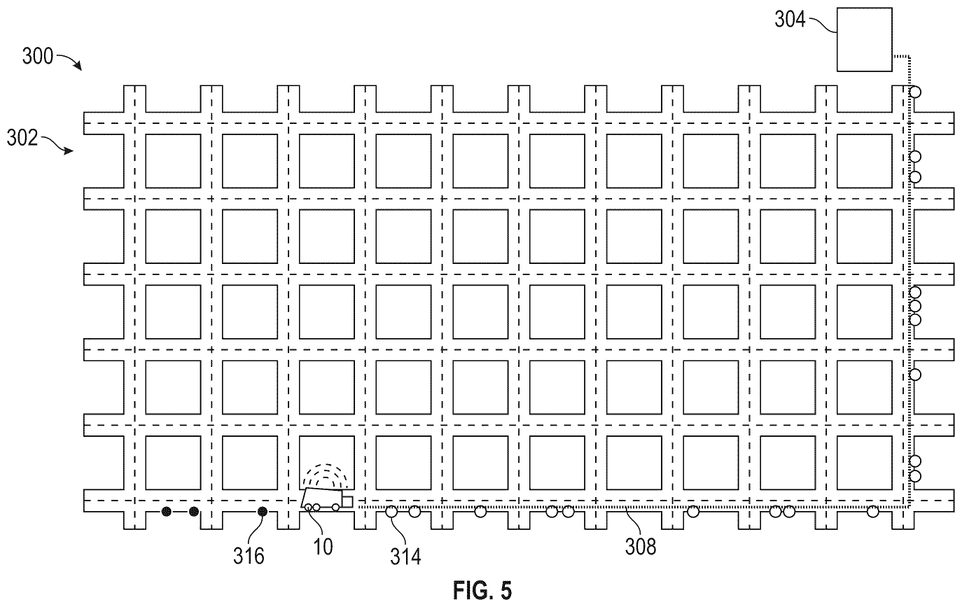

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Vehicle Awareness System

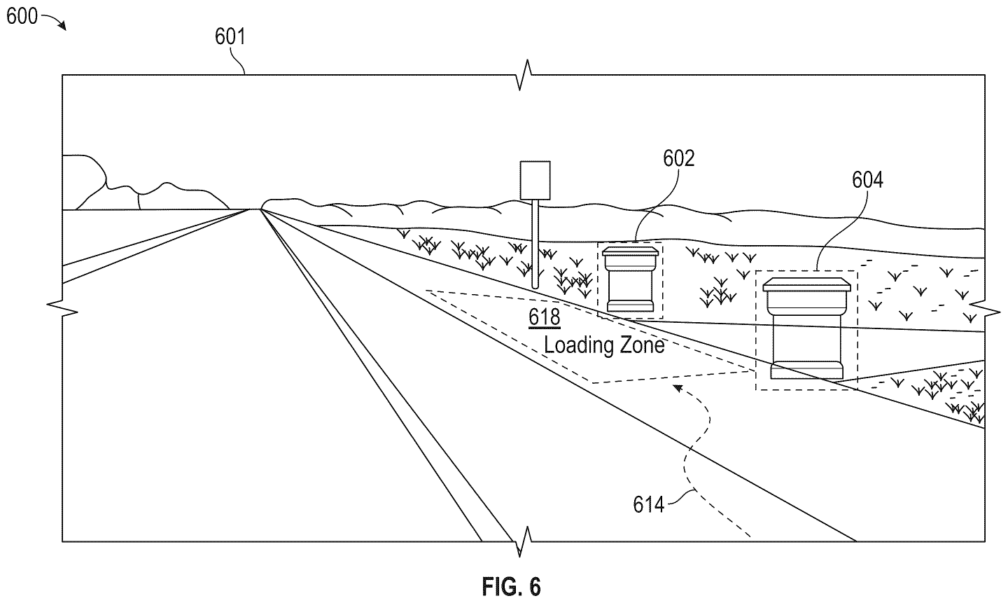

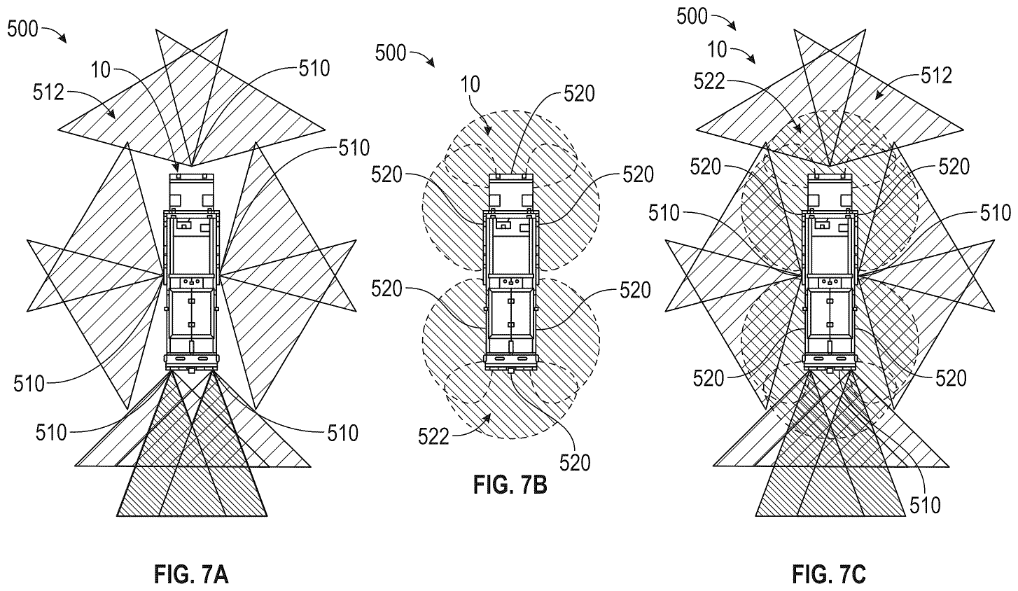

The refuse vehicle 10 of FIG. 1 may include one or more processors to execute one or more systems. The processors may be hosted locally on the refuse vehicle 10 and/or remotely (e.g., in a remote database). In one example, an autonomy system described herein may comprise several subsystems, components, processors, hardware, databases, servers, electronic device, instructions for execution, etc. The described autonomy system herein may autonomously or semi-autonomously operate a vehicle (e.g., the refuse vehicle 10 of FIG. 1) based on various inputs. In an exemplary embodiment, the autonomy system includes a vehicle awareness system 500, as described in FIGS. 6-7C. The vehicle awareness system 500 may be similar to the spatial awareness system as described in greater detail in U.S. Pat. 11/630,201, filed Apr. 16, 2021, the entire disclosure of which is incorporated by reference herein. The autonomy system may be similar to the object detector 420 as described in U.S. application Ser. No. 17/189,740, filed on Mar. 2, 2021, the entire disclosure of which is incorporated by reference herein. The autonomy system may also be similar to the processes and systems described in U.S. Pat. 11/527,072, filed on Oct. 18, 2018, the entire disclosure of which is incorporated by reference herein.

Turning now to FIGS. 7A-7C, an autonomy system of a vehicle (e.g., the refuse vehicle 10 of FIG. 1) includes a vehicle awareness system 500 (e.g., a detection system, a vision system, an environmental detection system, an environmental awareness system, etc.) that is configured to detect and identify the environment surrounding the vehicle. The environment may include adjacent objects, approaching objects, lane lines, obstacles, drivable surfaces, etc. The vehicle awareness system 500 may be configured to detect different types of objects such as refuse containers, vehicles, buildings, or any other object that may be adjacent the refuse vehicle. The vehicle awareness system 500 may use a variety of sensors, detectors, emitters, detection sub-systems, etc., to detect different types of objects. For example, the vehicle awareness system 500 may use the vision system 128 of FIG. 1 or one more of the sensors 126 of FIG. 1.

For example, the objects (e.g., refuse container) and the surrounding environment may be represented as a point cloud indicative of the position and orientation thereof relative to the vehicle 10 and/or the sensors (e.g., radar sensor(s), and/or the LIDAR sensor(s)). By way of example, the radar sensor(s) and/or the LIDAR sensor(s) may emit one or more signals (e.g., radio waves, laser beams, etc.) and sense the intensity of the reflections from the points where the signals reflected off surfaces of the objects and the surrounding environment. The vehicle controller are configured to detect and track movements of moving/stationary objects and characteristics thereof (as discussed in greater detail above) based on the vision data.

The vision data (e.g., point cloud data) may be used to generate a graphical representation (e.g., a two-dimensional representation, a three-dimensional representation) of the objects (e.g., the refuse container) and the surrounding environment to be displayed by the display. In some embodiments, the raw vision data (e.g., coordinates, distances, angles, speeds, etc.) of the objects and the surrounding environment are displayed by the display. In some embodiments, the radar sensor(s) and/or the LIDAR sensor(s) are configured to capture the vision data at a predetermined frequency (e.g., every second, every 500 milliseconds, at a frequency of about 5 Hz, 10 Hz, 50 Hz, 100 Hz, etc.) such that the graphical representation and the raw vision data of the objects and the surrounding environment are indicative of the current (e.g., real-time) position and orientation of the objects and the surrounding environment relative to the vehicle 10.

Referring back to FIGS. 7A-7C, the vehicle awareness system 500 of the vehicle may be configured to detect objects in a surrounding area of the refuse vehicle 10 that is proximate the refuse vehicle 10. In some embodiments, the vehicle awareness system 500 may include radar sensors 510 with sensing arcs 512 configured to detect objects in the surrounding area of the refuse vehicle 10. In some embodiments, the radar sensors 510 may be positioned on the exterior of the refuse vehicle 10 such that the sensing arcs 512 of the radar sensors 510 overlap to generate a 360-degree sensing area. In some embodiments, the radar sensors 510 are a combination of long and short-range sensors.

Referring to FIGS. 7A-7C, according to some embodiments, the vehicle awareness system 500 may include camera sensors 520 with sensing arcs 522. In some embodiments, the camera sensors 520 may include a visible light camera, infrared light camera, LiDAR sensor, radar sensor, ultrasonic sensor, and/or time-of-flight camera, which may be positioned on the exterior of the refuse vehicle 10 such that the sensing arcs 522 of the camera sensors 520 overlap to generate a 360-degree sensing area. In some embodiments, the camera sensors 520 are a combination of narrow-angle sensors and wide-angle sensors.

Referring to FIGS. 7A-7C, according to some embodiments, the vehicle awareness system 500 may include a combination of the radar sensors 510 with the sensing arcs 512 and the camera sensors 520 with the sensing arcs 522. The sensing arcs 512 of the radar sensors 510 and the sensing arcs 522 of the camera sensors 520 may combine to provide 360 or near-360 degree coverage of the perimeter of the vehicle.

It should be understood that the positioning and arrangement of the radar sensors 510 and the camera sensors 520 as described herein with reference to FIGS. 7A-7C are illustrative only and not intended to be limiting. For example, any of the radar sensors 510 or the camera sensors 520 may be disposed on a top of the vehicle such that the radar sensors 510 or the camera sensors 520 are configured to detect the presence and relative distance or position of overhead objects, obstacles, etc., proximate the vehicle.

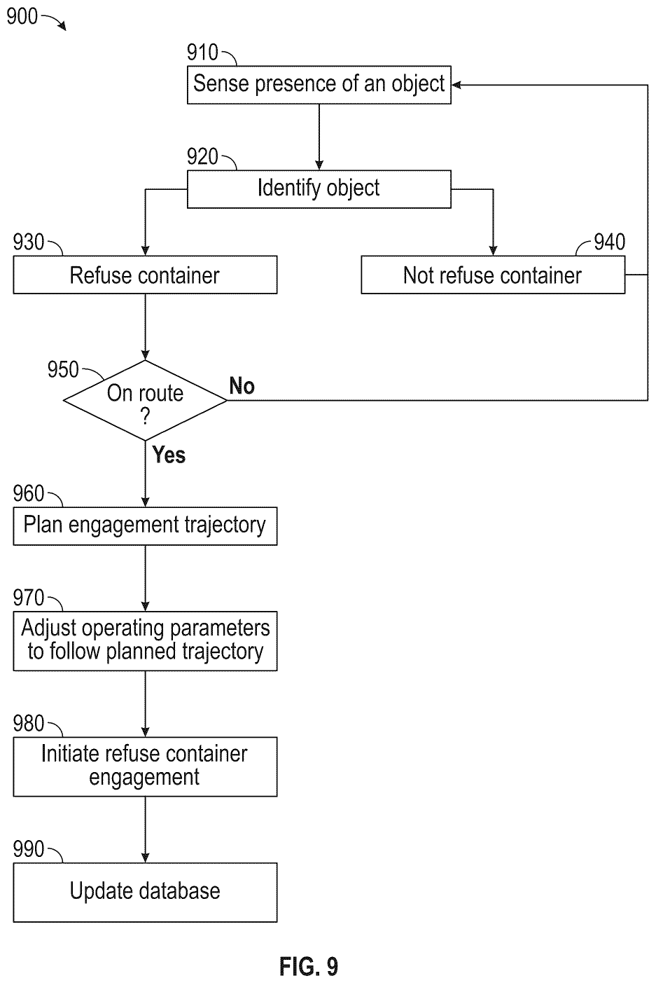

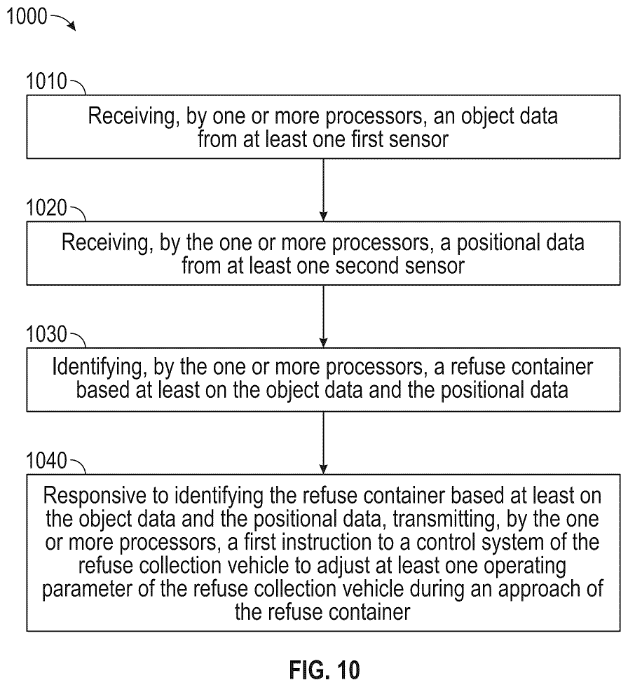

Turning now to FIG. 6, an illustration of an interface 601 of a vehicle awareness system 600 (e.g., the vehicle awareness system 500 of FIGS. 7A-7C) of a refuse vehicle is shown. Interface 601 may illustrate an example of a user interface presented to a user of controller 102 and/or refuse vehicle 10 of FIG. 1. Interface 601 may be presented to an operator of the refuse vehicle via a user interface of an electronic device associated with an operator of the refuse vehicle or the refuse vehicle itself. More generally, interface 601 illustrates the detection of objects (e.g., refuse containers) from data associated with objects around the refuse vehicle (e.g., on one or more sides) and captured by one or more image and/or object sensors. In some embodiments, interface 601 may be an example of an interface presented based on process 900 of FIG. 9 or process 1000 of FIG. 10.

In some embodiments, the image of interface 601 may represent an input image to vehicle awareness system 600. Vehicle awareness system 600 may be configured to detect any number of objects during operation of the refuse vehicle generally, and during an approach to a collection site more specifically. The vehicle awareness system 600 may be configured to detect at least refuse containers. As shown in FIG. 6, a first refuse container 602 and a second refuse container 604 have been detected (e.g., by the vehicle awareness system 600). Each of refuse container 602 and refuse container 604 are shown with a corresponding bounding box, indicating the object within interface 601 and a probability that the bounding box actually contains the detected object. The bounding boxes for each of the refuse container 602 and the refuse container 604 may not only indicate detected objects, but may indicate a location of each of refuse container 602, 604 within a captured images (e.g., the image presented in interface 601). In such embodiments, the vehicle awareness system 600 receives from the sensors object data and positional data of the detected objects. Object data may include, but is not limited to, an object's size, location, shape, color, identifying codes (e.g., QR code), weight, orientation, position, etc.

Each of the refuse container 602 and the refuse container 604 may be shown with a corresponding confidence value (e.g., 0.999 and 0.990, respectively). The confidence values may indicate a level of confidence that the associated bounding box actually contains a predicted object (e.g., a refuse container). As described above, objects with a confidence value below a threshold may be ignored (e.g., not presented with a bounding box as shown). In some embodiments, an operator (e.g., of refuse vehicle 10 of FIG. 1) may select a refuse container (e.g., the refuse container 602) to engage with (e.g., move to, pickup, and empty) from interface 601. For example, the user may select the refuse container 602 or the refuse container 604 via a user input device (e.g., by touching a particular refuse can via a touchscreen). In some embodiments, the user need not select one of the refuse container 602 or the refuse container 604 via a user input device to initiate an automatic pickup process. By way of example, in such embodiments, the system may correlate the received positional data to a pre-planned collection site based on customer data. Responsive to the received positional data and the pre-planned collection site meeting a threshold of similarity, the system may automatically execute the systems described herein to initiate and execute a refuse container collection process.

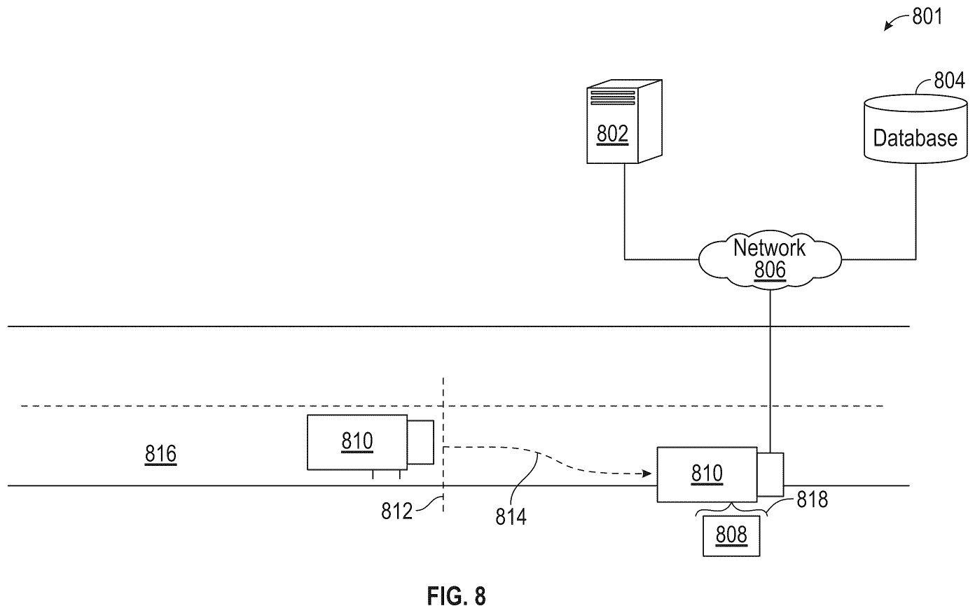

For example, the vehicle awareness system 600 may be configured to receive a pre-planned collection route (e.g., route 308 of FIG. 3) to determine if the identified refuse container 602 is associated with the pre-planned collection route that the vehicle is executing (manually or autonomously). The pre-planned collection route may include a route for the vehicle to travel. Along the route are collection sites at which the vehicle is directed to collect a refuse container. The collection sites may be associated with customers (or potential customers) of an entity (e.g., a refuse collection agency) associated with the vehicle. In identifying the refuse container 602 and its position by the vehicle awareness system 500 of FIGS. 7A-7CA, the vehicle awareness system 500 may determine whether or not the identified refuse container is associated with the pre-planned collection route. Responsive to the refuse container 602 being located on the pre-planned collection route and satisfying a threshold positional similarity with the pre-planned collection site, the trajectory planning system (e.g., the trajectory planning system 801 of FIG. 8) may automatically plan a collection trajectory for the vehicle to travel to in order to begin automatically collecting the refuse container 602. As described herein, this process may include updating one or more databases.

In another embodiment, if the refuse container 602 is identified has not being on the pre-planned collection route, the trajectory planning system is not engaged to plan a collection trajectory and the vehicle continues travelling past the identified refuse container 602.

### Trajectory Planning System

Turning now to FIG. 8, a trajectory planning system 801 (as briefly described above) is illustrated in greater detail. The trajectory planning system 801 may comprise of one or more of a server 802, a database 804, and one or more processors. According to an embodiment, the one or more processors may be communicably coupled to the vehicle 810.

FIG. 8 shows illustrative components of the trajectory planning system 801 for automating refuse collection by the vehicle 810, according to an embodiment. The trajectory planning system 801 may include a server 802, a database 804, and a vehicle 810 (or one or more processors in communication with the vehicle 810). In some embodiments, an electronic device including the one or more processors in communication with the vehicle 810 is not physically coupled to the vehicle 810 and is associated with an operator of the vehicle 810. The various devices and components of the trajectory planning system 801 may communicate with one another via one or more networks 806. In some embodiments, the trajectory planning system 801 may include a communication hub communicatively coupled to one or more vehicles 810 and the various other components of the trajectory planning system 801 for facilitating communications between the various components of the trajectory planning system 801 and the one or more vehicles 810.

For ease of description and understanding, FIG. 8 depicts the trajectory planning system 801 as having only one or a small number of each component. Embodiments may, however, comprise additional or alternative components, or omit certain components, from those of FIG. 8 and still fall within the scope of this disclosure. As an example, it may be common for embodiments to include multiple servers 802 and/or multiple databases 804 that are communicably coupled to the server 802 and the vehicle 810 through the network 806. Embodiments may include or otherwise implement any number of devices capable of performing the various features and tasks described herein. For instance, FIG. 8 depicts the database 804 as hosted as a distinct computing device from the server 802, though, in some embodiments, the server 802 may include an integrated database 804 hosted by the server 802.

The trajectory planning system 801 includes one or more networks 806, which may include any number of internal networks, external networks, private networks (e.g., intranets, VPNs), and public networks (e.g., Internet). The networks 806 comprise various hardware and software components for hosting and conduct communications amongst the components of the trajectory planning system 801. Non-limiting examples of such internal or external networks 806 may include a Local Area Network (LAN), Wireless Local Area Network (WLAN), Metropolitan Area Network (MAN), Wide Area Network (WAN), and the Internet. The communication over the networks 806 may be performed in accordance with various communication protocols, such as Transmission Control Protocol and Internet Protocol (TCP/IP), User Datagram Protocol (UDP), and IEEE communication protocols, among others.

The vehicle 810 may include an electronic device comprising hardware components (e.g., one or more processors, non-transitory storage) and software components capable of performing the various processes and tasks described herein. Non-limiting examples of the electronic device within vehicle 810 include personal computers (e.g., laptop computers, desktop computers), server computers, mobile devices (e.g., smartphones, tablets), VR devices, and gaming consoles, smart watches, onboard vehicle control devices, among other types of electronic devices. In some embodiments, the electronic device in the vehicle 810 may be the controller 102 of FIG. 4.

The server 802 may execute one or more software programs to perform various methods and processes described herein. The server 802 may include one or more computing devices configured to perform various processes and operations disclosed herein. In some embodiments, the server 802 may be a computer or computing device capable of performing methods disclosed herein. The server 802 may include a processor and non-transitory, computer readable medium including instructions, which, when executed by the processor, caused the processor to perform methods disclosed herein. The processor may include any number of physical, hardware processor. Although FIG. 8 shows only a single server 802, the server 802 may include any number of computing devices. In some cases, the computing devices of the server 802 may perform all or portions of the processes and benefits of the server 802. The server 802 may comprise computing devices operating in a distributed or cloud computing configuration and/or in a virtual machine configuration. It should also be appreciated that, in some embodiments, functions of the server 802 may be partly or entirely performed by the vehicle 810 or the above-referenced one or more processors.

In an example, the vehicle 810 may execute one or more software programs to perform various methods and processes described herein. The vehicle 810 may include one or more computing devices configured to perform various processes and operations disclosed herein. In some embodiments, the vehicle 810 may include a computer or computing device capable of performing methods disclosed herein. In some embodiments, the vehicle 810 may include a mobile computing device (e.g., cellular device). The vehicle 810 may include a processor and non-transitory, computer-readable medium including instructions, which, when executed by the processor, caused the processor to perform methods disclosed herein. The processor may include any number of physical, hardware processors. Although FIG. 8 shows only a single vehicle 810, the vehicle 810 any include any number of computing devices. In some cases, the computing devices of the vehicle 810 may perform all or portions of the processes and benefits of the vehicle 810. The vehicle 810 may comprise computing devices operating in a distributed or cloud computing configuration and/or in a virtual machine configuration.

The trajectory planning system 801 may be executed to autonomously plan a refuse collection trajectory 814 and autonomously operate the vehicle 810 to execute the planned refuse collection trajectory 814. By way of example, the vehicle 810 may include an engagement assembly 818 (e.g., refuse container grabber, forks, etc.). The engagement assembly 818 may be used to couple to an object 808 (e.g., a refuse container) and/or lift the object 808 for emptying.

The trajectory planning system 801 may be communicatively coupled with the vehicle awareness system 500 of FIGS. 7A-7C. Through this communicative coupling, the trajectory planning system 801 may receive object data and/or positional data from and/or transmit to the vehicle awareness system 500. By way of example, the trajectory planning system 801 may receive an indication of the presence of the object 808 from the vehicle awareness system 500. The vehicle awareness system 500 may transmit to the trajectory planning system 801 a class of the object 808, a position of the object 808, an estimated weight of the object 808, an estimated volume of the object 808, an orientation of the object 808, a position of the vehicle 810, a trajectory of the vehicle 810, speed of the vehicle 810, an acceleration of the vehicle 810, a gear engagement of the vehicle 810, suspension stiffness of the vehicle 810, speed limit of a drivable service 816 (e.g., a road), a time of day, a date, a pre-planned collection route, a location of a client associated with the pre-planned collection route, client data, engagement assembly 818 parameters, etc. The trajectory planning system 801 may use this received data to automatically plan a collection trajectory (and corresponding vehicle 810 adjustments) for the vehicle 810 to collect the object 808 with the engagement assembly 818.

The trajectory planning system 801 may use the received data to identify the location of the object 808 relative to the vehicle 810 and determine an optimal path of transportation for the vehicle 810 in order for the engagement assembly 818 to engage with the object 808. One or more of the trajectory planning system 801 and the vehicle awareness system 500 of FIGS. 7A-7C may autonomously operate the vehicle 810 along the planned collection trajectory 814 to the object 808. Additionally, or alternatively, one or more of the trajectory planning system 801 and the vehicle awareness system 500 of FIGS. 7A-7C can operate a display screen to provide an augmented reality or overlaid imagery of the collection trajectory 814 such that the operator of the vehicle 810 can transport the vehicle 810 along the collection trajectory 814 to the object 808. In some embodiments, the trajectory planning system 801 may use a threshold 812 to trigger one or more operations performed by the trajectory planning system 801. For example, the threshold 812 may be used to trigger the initiation of autonomous control along the collection trajectory 814, prompting of the user to initiate autonomous/semi-autonomous control along the collection trajectory 814, planning the collection trajectory 814, preparing the vehicle 810 for collection (e.g., warming a battery, opening/adjusting the engagement assembly 818, etc.), etc. In some embodiments, the threshold 812 may be set to a specific distance (e.g., 50 feet) from a determined/planned collection site.

As shown in FIG. 6, the interface 601 that can be generated by a display manager and displayed on a user interface which may include image data, the collection trajectory 814, and or an indication of a bounded loading zone 618. The image data may be image data obtained from the vision system 128 of FIG. 1 at a front of the vehicle 810 of FIG. 8. The route display data can include a refuse vehicle path (e.g., route 308 of FIG. 5) and engagement apparatus visualizations that are superimposed over the image data that is obtained from the vision system 128 of FIG. 1 at the front of the vehicle 810. The collection trajectory 614, indication of the bounded loading zone 618, and/or the engagement apparatus path visualizations are shown guiding the vehicle to the refuse container 602 such that the engagement assembly engages with the refuse container 602. In some embodiments, the interface 601 on which the GUI is displayed is integrated into a windshield of the vehicle 810 (of FIG. 8) such that the interface 601 provides an augmented reality display of the refuse vehicle path and the engagement apparatus path visualizations

Referring back to FIG. 8, upon planning the collection trajectory 814, the trajectory planning system may transmit one or more signals to control operation of one or more operating parameters of the vehicle 810. Operating parameters of the vehicle 810 may include, but are not limited to, a braking amount, a steering angle, an acceleration amount, a gear engagement, a suspension stiffness, an engagement assembly actuation, refuse container grabber actuation, a lift device actuation, a refuse collection actuation (e.g., opening a tailgate or trash chute), and a compaction apparatus. These operating parameters may be adjusted automatically in response to receiving the one or more signals. In one embodiment, the trajectory planning system 801 controls (or causes to control) the vehicle 810 to travel along the collection trajectory 814 and initiate operation of the engagement assembly 818 to collect the object 808 upon arriving at the identified object 808 (e.g., the refuse container 602 of FIG. 6).

In response to autonomously/semi-autonomously travelling on the planned collection trajectory 814 and collecting the object 808 (e.g. emptying the contents of a refuse container into the vehicle 810), one or more of the systems described herein may automatically generate a report of the collection of the object 808 and transmit (automatically or upon receiving an approval of the operator) the generated report to the server 802 and/or the database 804 through the network 806. The report may include one or more data associated with the collection of the object 808 including, but not limited to a class of the object 808, a position of the object 808, an estimated weight of the object 808, an estimated volume of the object 808, an orientation of the object 808, a position of the vehicle 810, a trajectory of the vehicle 810, speed of the vehicle 810, an acceleration of the vehicle 810, a gear engagement of the vehicle 810, suspension stiffness of the vehicle 810, speed limit of a drivable service 816 (e.g., a road), a time of day, a date, a pre-planned collection route, a location of a client associated with the pre-planned collection route, client data, engagement assembly 818 parameters, etc. Additionally, the vehicle 810 may identify through on or more sensors and/or processors the contents of the object 808, a weight of the contents of the object 808, a volume of the contents of the object 808, whether a collection occurred, if the operator exited the truck during the collection, etc. The report may also include these identified data of the collection of the object 808.

Turning now to FIG. 9 an example process 900 of operating a vehicle is shown, according to an exemplary embodiment. The process 900 may include steps 910-990. The process 900 can be performed by the vehicle awareness system 500 of FIGS. 7A-7C, the trajectory planning system 801 of FIG. 8, and/or one or more processors of the vehicle awareness system 500 or the trajectory planning system 801. In one embodiment, the process 900 is implemented to to detect the presence of a refuse container in a surrounding area of the vehicle, autonomously transport the vehicle to the refuse container (or to provide guidance to an operator of the vehicle to transport the vehicle to the refuse container), collect the contents of the refuse container, and update a database with data associated with the collection of the contents of the refuse container.

The process 900 includes sensing the presence of an object in step 910. Step 910 may include obtaining image data from cameras of a refuse vehicle, according to some embodiments. Step 910 can be performed by a controller of the vehicle by obtaining the image data from one or more cameras associated with and/or communicatively coupled to the vehicle. The image data may be externally or outwards facing visible light cameras that are mounted about the refuse vehicle (e.g., on the front of the refuse vehicle 10 on the rear of the refuse vehicle as a backup camera, etc.) and configured to obtain image data of surrounding areas of the refuse vehicle 10. The image data may indicate the presence of one or more refuse containers to be picked up and emptied into a hopper of the refuse vehicle 10. Additionally, or alternatively, step 910 may include receiving/obtaining data from one or more additional sensors (e.g., radar sensors, LiDAR sensors, infrared sensors, time-of-flight camera, etc.).

The process 900 also includes identifying the object based on the collected data (step 920), according to some embodiments. Step 920 may be performed by the one or more processors by implementing the functionality of vehicle awareness system 500 of FIGS. 7A-7C (e.g., an image analysis technique, an image detection technique). Step 920 may include identifying an orientation and position of each of multiple refuse containers that are present in the received data.

In identifying the object in step 920, the one or more processors determine whether the object is a refuse container (step 930) or not a refuse container (step 940). At step 940, if the sensed object is identified as not a refuse container, then the process reverts to step 910 to sense a new object.

If the sensed object is identified as a refuse container at step 930, then the one or more processors determine if the refuse container is positioned on a pre-defined collection route (step 950). The object may be identified as a refuse container through various methods and means as described in the various references incorporated by reference herein. These may include using machine learning, artificial intelligence, or other computer-implemented methods.

In some embodiments, the system executing the process 900 may receive an indication of a collection route (e.g., the route 308 of FIG. 5) associated with one or more collection sites. The collection sites may be associated with a client address or a transfer station (e.g., a landfill). In some embodiments, the collection sites are associated with customers or potential customers of a refuse collection agency.

Upon determining that the identified refuse container is not on the collection route, the process 900 reverts to step 910 or ends. Upon determining that the identified refuse container is on the collection route, the system executing the process 900 (e.g., the trajectory planning system 801 of FIG. 8) plans an engagement (e.g., collection) trajectory (e.g., the collection trajectory 814 of FIG. 8) at step 960. The system determines an optimal engagement trajectory between a determined current location of the vehicle and the determined location of the identified refuse container. The engagement trajectory may account for the orientation of the refuse container and adjust the engagement trajectory to direct the vehicle to a position in which the vehicle may engage with the refuse container through the engagement assembly of the vehicle. The engagement trajectory may include additional data other than simply the path for the vehicle to travel. For example, the engagement trajectory may also include indications of the various changes to the operating parameters needed to travel the engagement trajectory. The engagement trajectory may be planned based on data received at step 910, step 920, etc. Additionally, or alternatively, the engagement trajectory may be planned based on received data from one or more databases (e.g., the database 804 of FIG. 8). For example, the system may receive map data from a database or server, collection site data from a database or server, collection data from a second vehicle, etc.

Responsive to finalizing at least a portion of the engagement trajectory, the system may adjust one or more of the operating parameters to follow the planned trajectory. In some embodiments, the system may require initiation of the autonomous control by the operator of the vehicle prior to adjusting operating parameters of the vehicle (e.g., through an indication on an electronic device associated with the operator or the vehicle). In other embodiments, the system may have a default autonomy system that initiates autonomous control upon the engagement trajectory being planned. For example, the vehicle may have collection mode, in which the operator operates the vehicle until a threshold distance from a planned/identified collection site (e.g., 50 feet) or the refuse container on the collection route is identified and a collection/engagement trajectory is planned. In such embodiments, the vehicle may automatically adjust from a manual mode of operation to automatic mode of operation. In the automatic mode of operation, the system automatically adjusts the operating parameters of the vehicle during the approach to, and collection of, the refuse container. In this manner, the operator is free to engage in other activities, such as supervising control of the vehicle or updating records during the approach to and collection of the refuse container.

Step 970 may include operating a display device to prompt the operator to either activate autonomous refuse collection or to bypass autonomous refuse collection. Step 970 can include generating, transmitting, and executing controls for a driveline, a braking system, a lift apparatus or lift device, a steering system, etc., of the vehicle in order to transport the refuse vehicle to the refuse container along the engagement trajectory. Step 980 includes performing a lifting and emptying operation of the lift apparatus once the refuse vehicle has arrived at the refuse container. The lifting and emptying operation are used to engage the engagement assembly of the vehicle with the refuse container, transport the refuse container to a refuse compartment, and/or emptying the contents of the refuse container into the refuse compartment. In some embodiments, the one or more processors may either cause to control the vehicle and engagement assembly directly or may transmit signals to one or more subsystems to control the vehicle.

Upon traveling the engagement trajectory and collecting the refuse container, the system executing the process 900 may receive an indication of the completion of the collection of the refuse container (e.g., by the user through an electronic device, automatically from one or more sensors of the vehicle, etc.). Upon receiving this indication, the system may update one or more databases based at least on one of the received indication of collection, the location of the refuse container, the position of the vehicle, a weight of the contents collected, a volume of the contents collected, a type of contents collected, a time of collection, a date of collection, a position of the refuse container, an orientation of the refuse container, etc. (step 990).

Turning now to FIG. 10, a flowchart of an example process 1000 for adjusting an operation of a vehicle (e.g., the refuse vehicle 10 of FIG. 1). The process 1000 may include steps 1010-1040. At step 1010, one or more processors receive an object data from at least one first sensor. At step 1020, the one or more processors receive a positional data from at least one second sensor. At step 1030, the one or more processors identify a refuse container based at least on the object data and the positional data. At step 1040, responsive to identifying the refuse container based at least on the object data or the positional data, the one or more processors transmit a first instruction to a control system of the refuse collection vehicle to adjust at least one operating parameter of the refuse collection vehicle during an approach of the refuse container. In some embodiments, upon approaching the refuse container and emptying the contents of the refuse container into the refuse collection vehicle, the one or more processors update a database with data associated with the collection of the refuse container, as described in FIG. 9.

Upon completing step 1040, the process may proceed with one or more steps. By way of example, responsive to identifying the refuse container and transmitting the first instruction to the control system of the refuse collection vehicle to adjust the at least one operating parameter of the refuse collection vehicle during the approach, the one or more processors may transmit a second instruction to cause an actuation of an engagement assembly to engage the refuse container. The second instruction may be initiated upon arriving at a location within a loading zone (e.g., the loading zone 618 of FIG. 6). In some embodiments, the second instruction is transmitted upon the refuse collection vehicle arriving at the loading zone and coming to a stop (or dropping below a threshold velocity/speed). The second instruction may cause the engagement assembly to extend, move, grab, collect, etc. such that the engagement assembly engages with the refuse container.

Responsive to receiving an indication of an engagement of the refuse container with the engagement assembly, the one or more processors may update a database based at least on the positional data and the indication of the engagement of the refuse container with the engagement assembly. The indication of engagement between the engagement assembly and refuse container may come from one or more engagement sensors, such as, but not limited to, a visible light camera, an infrared camera, a LiDAR sensor, a radar sensor, a strain gauge, and a time-of-flight camera. The visible light camera may use computer vision processing to determine that the refuse container has been engaged. In a similar fashion, the LiDAR sensor, radar sensor, and/or time-of-flight camera may collect sensor data indicative of an interaction between the refuse container and the engagement assembly which can then be transmitted to the one or more processors. The engagement sensor may be a strain gauge. The strain gauge within, or coupled to, the engagement assembly may receive sensor data indicative of an engagement between the engagement assembly and the refuse container. The strain gauge may receive data indicating that the engagement assembly is lifting the refuse container based on a strain exerted on the engagement assembly in lifting the refuse container.

The system described herein may execute one or more steps of the process 900 of FIG. 9 and/or the process 1000 of FIG. 10. Steps between the processes may be substituted, added, or removed to execute any combination of the process 900 and the process 1000.

In the present disclosure, the terms system and server may be used interchangeably. The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for controlling an operation of a refuse collection vehicle, the system comprising:
at least one first sensor coupled to the refuse collection vehicle and configured to detect objects on one or more sides of the refuse collection vehicle during an approach;
at least one second sensor configured to detect a position of the refuse collection vehicle during the approach; and
one or more processors configured to:
receive an object data from the at least one first sensor;
receive a positional data from the at least one second sensor;
identify a refuse container based at least on the object data and the positional data; and
responsive to identifying the refuse container based at least on the object data, transmit a first instruction to a control system of the refuse collection vehicle to adjust at least one operating parameter of the refuse collection vehicle during the approach.

2. The system of claim 1, wherein the at least one first sensor is at least one of a visible light camera, an infrared camera, a LiDAR sensor, a radar sensor, and a time-of-flight camera.

3. The system of claim 1, wherein the at least one operating parameter is one of a braking amount, a steering angle, an acceleration amount, a gear engagement, a suspension stiffness, and a refuse container grabber actuation.

4. The system of claim 1, further comprising:
responsive to identifying the refuse container and transmitting the first instruction to the control system of the refuse collection vehicle to adjust the at least one operating parameter of the refuse collection vehicle during the approach, transmit a second instruction to cause an actuation of an engagement assembly to engage the refuse container; and
responsive to receiving an indication of an engagement of the refuse container with the engagement assembly, update a database based at least on the positional data and the indication of the engagement of the refuse container with the engagement assembly.

5. The system of claim 4, wherein receiving an indication of an engagement of the refuse container with the engagement assembly includes receiving a signal from an engagement sensor.

6. The system of claim 5, wherein the engagement sensor is one of a visible light camera, an infrared camera, a LiDAR sensor, a radar sensor, a strain gauge, and a time-of-flight camera.

7. The system of claim 4, wherein the engagement assembly includes at least one of a refuse container grabber and a fork.

8. A method controlling an operation of a refuse collection vehicle, the method comprising:
receiving, by one or more processors, an object data from at least one first sensor;
receiving, by the one or more processors, a positional data from at least one second sensor;
identifying, by the one or more processors, a refuse container based at least on the object data and the positional data; and
responsive to identifying the refuse container based at least on the object data and the positional data, transmitting, by the one or more processors, a first instruction to a control system of the refuse collection vehicle to adjust at least one operating parameter of the refuse collection vehicle during an approach of the refuse container.

9. The method of claim 8, wherein the at least one first sensor is at least one of a visible light camera, an infrared camera, a LiDAR sensor, a radar sensor, and a time-of-flight camera.

10. The method of claim 8, wherein the at least one operating parameter is one of a braking amount, a steering angle, an acceleration amount, a gear engagement, a suspension stiffness, and a refuse container grabber actuation.

11. The method of claim 8, further comprising:
responsive to identifying the refuse container and transmitting the first instruction to the control system of the refuse collection vehicle to adjust the at least one operating parameter of the refuse collection vehicle during the approach, transmitting, by the one or more processors, a second instruction to cause an actuation of an engagement assembly to engage the refuse container; and
responsive to receiving an indication of an engagement of the refuse container with the engagement assembly, updating, by the one or more processors, a database based at least on the positional data and the indication of the engagement of the refuse container with the engagement assembly.

12. The method of claim 11, wherein receiving an indication of an engagement of the refuse container with the engagement assembly includes receiving a signal from an engagement sensor.

13. The method of claim 12, wherein the engagement sensor is one of a visible light camera, an infrared camera, a LiDAR sensor, a radar sensor, a strain gauge, and a time-of-flight camera.

14. The method of claim 11, wherein the engagement assembly includes at least one of a refuse container grabber and a fork.

15. A refuse collection vehicle comprising:
at least one first sensor coupled to the refuse collection vehicle and configured to detect objects on one or more sides of the refuse collection vehicle during an approach;
at least one second sensor configured to detect a position of the refuse collection vehicle during the approach; and
one or more processors configured to:
receive an object data from the at least one first sensor;
receive a positional data from the at least one second sensor;
identify a refuse container based at least on the object data and the positional data; and
responsive to identifying the refuse container based at least on the object data, transmit a first instruction to a control system of the refuse collection vehicle to adjust at least one operating parameter of the refuse collection vehicle during the approach.

16. The refuse collection vehicle of claim 15, wherein the at least one first sensor is at least one of a visible light camera, an infrared camera, a LiDAR sensor, a radar sensor, and a time-of-flight camera.

17. The refuse collection vehicle of claim 15, wherein the at least one operating parameter is one of a braking amount, a steering angle, an acceleration amount, a gear engagement, a suspension stiffness, and a refuse container grabber actuation.

18. The refuse collection vehicle of claim 15, further comprising:
responsive to identifying the refuse container and transmitting the first instruction to the control system of the refuse collection vehicle to adjust the at least one operating parameter of the refuse collection vehicle during the approach, transmit a second instruction to cause an actuation of an engagement assembly to engage the refuse container; and
responsive to receiving an indication of an engagement of the refuse container with the engagement assembly, update a database based at least on the positional data and the indication of the engagement of the refuse container with the engagement assembly.

19. The refuse collection vehicle of claim 18, wherein receiving an indication of an engagement of the refuse container with the engagement assembly includes receiving a signal from an engagement sensor.

20. The refuse collection vehicle of claim 19, wherein the engagement sensor is one of a visible light camera, an infrared camera, a LiDAR sensor, a radar sensor, a strain gauge, and a time-of-flight camera.
